(19) United States
(12) Patent Application Publication
(10) Pub. No.: US 2009/0071750 A1
(43) Pub. Date: Mar. 19, 2009

(54) RESCUE LANYARD AND KIT FOR EMERGENCY DESCENT FROM A HEIGHT INCLUDING AN EMERGENCY DESCENT CONTROL DEVICE

(75) Inventors: MARCO SIMARD, Brossard (CA); Daniel Landry, Terrebonne (CA)

Correspondence Address: VENABLE LLP, P.O. BOX 34385, WASHINGTON, DC, 20043-9998, US

(73) Assignees: NOUVELLE HAUTEUR INC., Brossard (Quebec) (CA); SELF RESCUE INC., Montreal (Quebec) (CA)

(21) Appl. No.: 12/208,734

(22) Filed: Sep. 11, 2008

Related U.S. Application Data
(60) Provisional application No. 60/972,278, filed on Sep. 14, 2007.
(60) Provisional application No. 61/030,404, filed on Feb. 21, 2008.

(51) Int. Cl. A62B 1/06; A62B 35/00; A47L 3/04

(52) U.S. Cl. 182/5; 182/3; 182/191

(57) ABSTRACT

A rescue lanyard is described herein to be used with a safety harness worn by a person. The lanyard comprises a main strap having a first attachment portion for attaching the main strap to a structure and a second attachment portion for attaching the main strap to the harness, and a secondary strap secured to the main strap adjacent the first attachment portion and having a third attachment portion to be attached to the harness via an emergency descent control device. In a safety mode of operation, the first attachment portion of the main strap is attached to the harness and the second attachment portion is attached to a structure so as to retain the person wearing the harness during a fall. In a self rescue mode of operation following a fall, while the person hang from the main strap, the third attachment portion is first attached to the harness via the emergency descent control device and the main strap is then cut so as to allow the person to descent from the structure using the descending device. The emergency control device includes a rope, a rope friction controller having an attachment portion for securing the device to the harness, a rope friction controller for selectively applying friction on the rope, and a safety element for applying friction on the rope so as to prevent movement thereof in the rope friction controller in a panic mode of operation.

### CROSS-REFERENCE TO RELATED APPLICATION

This application claims the benefit of U.S. Provisional Application No. 60/972,278, filed Sep. 14, 2007 and Provisional Application No. 61/030,404 filed Feb. 21, 2008, the contents of both applications being incorporated herein by reference in their entirety.

### BACKGROUND

It is conventionally accepted and regulated by governing bodies that a worker that has to climb in the course of its work or that otherwise works above a specific height must wear a safety harness that is so secured as to prevent the worker from accidentally falling to the ground.

Such a safety harness, which can also be used as an emergency evacuation device, is usually attached to a structure with a lanyard that is long enough to give to the worker enough freedom to carry on the work but short enough to prevent his fall to the ground or to hit any obstacle should the worker falls from the structure. Following a fall, the lanyard allows the worker to remain suspended from the structure, waiting to be rescued.

A problem with such a set-up may occur when the worker is alone or in any situations where help may take time to arrive. Indeed, being suspended by a harness may cause problems, such as a blood circulation problem called orthostatic intolerance or suspension trauma, if it lasts too long.

Many devices are known in the art to allow a control descent from a height. Such devices allow applying a control friction on a rope used to descent, thereby controlling the speed of the descent.

Some of these devices, often referred to as descenders, include automatic braking of the rope when they are not operated by the user.

However, none of the known emergency descent control device from the prior art is at the same time simple in its operation, reliable, heavy-duty and includes an emergency brake feature which allow stopping the fall when the user is in a state of shock and/or wrongly operates the device.

### BRIEF DESCRIPTION OF THE DRAWINGS

In the appended drawings:

FIG. 1 is a perspective view of a rescue lanyard according to an illustrative embodiment of the present invention; the rescue lanyard being shown in a folded configuration;

FIG. 2 is a perspective view of the rescue lanyard of FIG. 1; the rescue lanyard being shown in a deployed operational configuration;

FIGS. 3 to 9 illustrate the steps for safely operating the rescue lanyard in an emergency situation;

FIG. 10 is a top plan view of an emergency descent control device according to a second illustrative embodiment of the present invention; the emergency descent control device being shown secured to the front D-ring of a harness;

FIGS. 11 to 13 are partially sectional top plan views of the emergency descent control device from FIG. 10, illustrating the operation thereof;

FIG. 14 is a perspective view of the emergency descent control device from FIG. 10; and

FIG. 15 is a partially sectional top plan view of an emergency descent control device according to a third illustrative embodiment of the present invention.

While the invention will be described in conjunction with illustrated embodiments, it will be understood that it is not intended to limit the scope of the invention to such embodiments.

### DETAILED DESCRIPTION

In accordance with a first aspect of the present invention, there is provided a rescue lanyard to be used with a wearable safety equipment worn by a person, the lanyard comprising:

a main link having a first attachment portion for attaching the main link to a structure and a second attachment portion for attaching the main link to the wearable safety equipment;

a secondary link secured to the main link adjacent the first attachment portion and having a third attachment portion to be attached to the wearable safety equipment via a descending device;

whereby, in a safety mode of operation, the first attachment portion of the main link is attached to the wearable safety equipment and the second attachment portion is attached to the structure so as to retain the person wearing the wearable safety equipment during a fall; in a rescue mode of operation of the rescue lanyard following a fall, while the person hang from the main link, the third attachment portion is first attached to the wearable safety equipment via a descending device and the main link then being cut so as to allow the person to descent from the structure using the descending device.

According to a second aspect of the present invention, there is provided a kit for an emergency descent from a high structure to be used with a wearable safety equipment, the kit comprising:

a rescue lanyard as recited in claim 1; and

an emergency descent control package including an emergency descent control device including a rope-friction controller to be secured to both the wearable safety equipment and to the rescue lanyard therebetween, a rope operatively coupled with the rope-friction controller, and a link cutter for cutting the main link of the rescue lanyard in a rescue mode of operation thereof after the rope-friction controller is secured to both the wearable safety equipment and to the rescue lanyard; the rope together with the rope-friction controller allowing for a controlled descent from the high structure of a user wearing the wearable safety equipment after i) the rope-friction controller is secured to both the wearable safety equipment and to the rescue lanyard and ii) the main link of the rescue lanyard is cut.

According to a third aspect of the present invention, there is provided an emergency descent control device to be secured to a wearable safety equipment, the device comprising:

a rope;

a rope friction controller having an attachment portion for securing the device to the wearable safety equipment and defining a pivot axis for the device, a rope-receiving portion having a rope inlet and a rope outlet for receiving a portion of the rope and for selectively applying friction thereon, and a handle portion distanced from the attachment portion for pivoting the rope friction controller about the pivot axis from a neutral position wherein friction is so applied on the rope as to prevent movement thereof in the rope-receiving portion to a descent position wherein minimal friction is applied on the rope so as to allow movement thereof in the rope-receiving portion; and

a safety element positioned in the rope outlet for applying friction on the rope so as to prevent movement thereof in the rope-receiving portion when the rope friction controller is pivoted beyond the descent position from the neutral position.

Other objects, advantages and features of the present invention will become more apparent upon reading the following non restrictive description of illustrated embodiments thereof, given by way of example only with reference to the accompanying drawings.

In the following description, similar features in the drawings have been given similar reference numerals, and in order not to weigh down the figures, some elements are not referred to in some figures if they were already identified in a precedent figure.

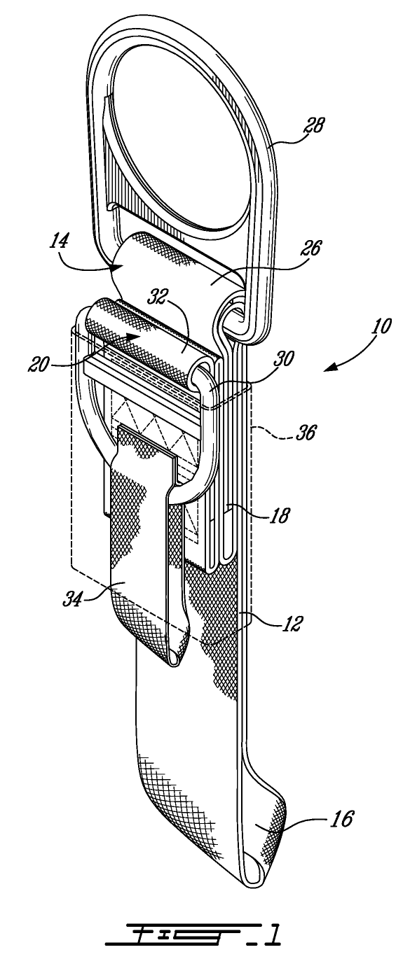

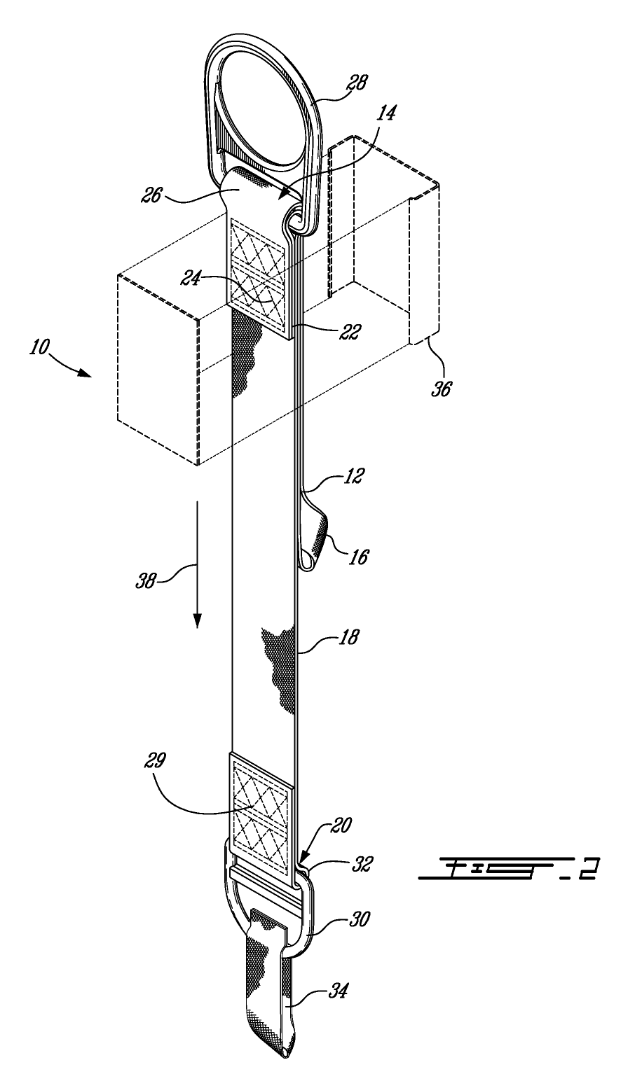

Turning now to FIGS. 1 and 2 of the appended drawings, a rescue lanyard 10 according to an illustrative embodiment of the present invention will be described.

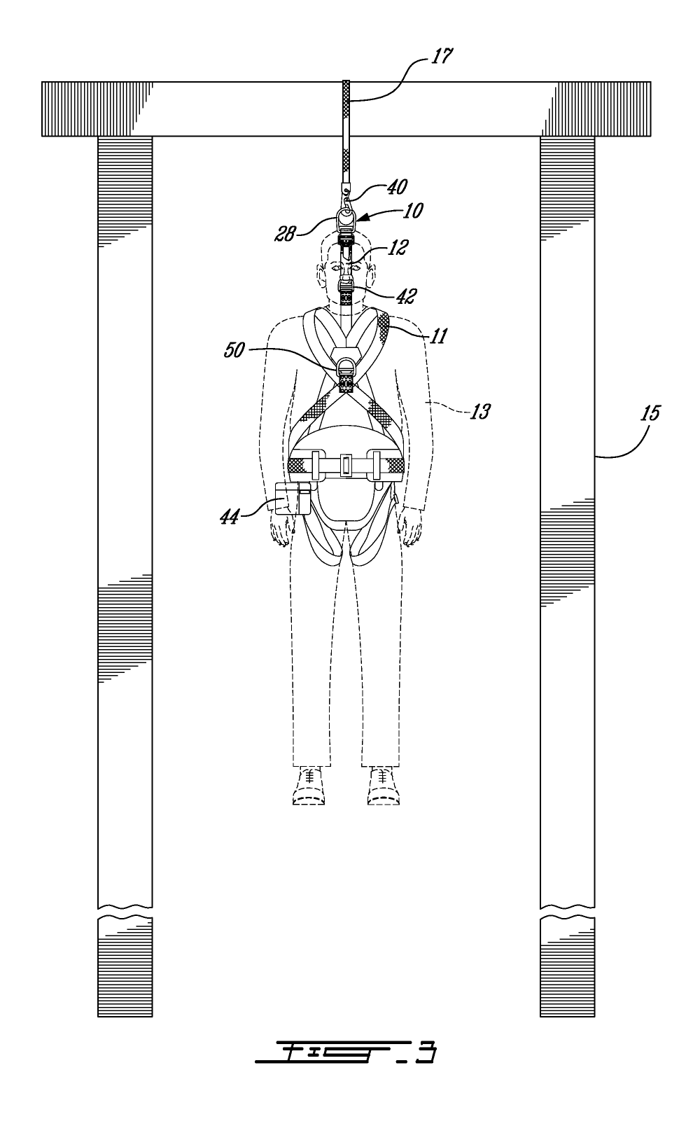

As will be described hereinbelow in more detail, the rescue lanyard 10 is to be used with wearable safety equipment, such as a safety harness 11, worn by a person 13 during the course of its work or of any other activity occurring on a high structure 15 (see FIG. 3).

As can be seen on FIG. 3, more specifically, the rescue lanyard 10 allows attaching the person 13 to the structure 15 by securing the harness 11 to a cable 17, to any fall protection connecting element (not shown) or to any other element part or mounted to the structure 15 via the lanyard 10. As will be described furtherin, the rescue lanyard 10 further allows creating a secondary connection between the person 13 and the structure 15 that may be deployed in an emergency situation and to which a descent device 46 may be attached to allow the person 13 to rescue himself by safely descending to the ground after the primary connection has been cut.

The rescue lanyard 10 comprises a main strap 12 having a first attachment portion 14 for attaching a first end of the main strap 12 to the structure 15 and a second attachment portion, in the form of a loop 16, for attaching the second end of the main strap 12 to the harness 11.

The lanyard 10 further comprises a secondary strap 18, secured via one of its end to the main strap 12, adjacent the first attachment portion thereof, and having a third attachment portion 20 at its other end for attaching the secondary strap 16 to the harness 11 via the emergency descent control device 46 as will be described hereinbelow in more detail.

The main and secondary straps 12 and 18 are made of nylon, polyester, a combination thereof or of any other equivalent load bearing material known in the art.

The main and secondary straps 12 and 18 are secured to one another by an overlap 22 of the main strap 12 sewed over a first permanently folded portion 24 of the secondary strap 18. The overlap 22 and the fold 24 together define a main loop 26 which receives a main D-ring 28 defining part of the first attachment portion 14.

The third attachment portion 20 of the secondary strap 18 further includes a second permanent fold 29, which is sewed to define a secondary loop 32 which receives a secondary D-ring 30 defining part of the third attachment portion 20. A release loop 34 is attached to the secondary D-ring, the purpose of which will be described hereinbelow.

As illustrated in FIG. 1, the secondary strap 18 is initially held in a folded configuration by a breakable but sturdy pouch 36 which is shown in dashed lines in FIGS. 1 and 2.

The pouch 36 is made of a light fabric. It can also be made of a polymeric material or of any material that can be easily broken.

FIG. 2 illustrates the rescue lanyard 10 in its rescue position, i.e. when the pouch 36 has been broken by a user that pulled on the loop 34 with sufficient force (see arrow 38). As can be seen from this figure, the secondary strap 18 is longer than the primary strap 14. Optionally, the pouch 34 may include perforations facilitating its intentional breakage.

According to a further illustrative embodiment (not shown), the loop 34 is omitted and the secondary D-ring 30 is used to pull on the secondary strap 18. According to still a further illustrative embodiment of the present invention (not shown), the secondary strap 18 is configured so that part of the third attachment portion 20 extends from the pouch 36 to allow some grip for the user 13 to pull on the secondary strap 18 for its release.

It is to be noted that elements present in the composition of the rescue lanyard 10 advantageously meets or exceeds CSA or ANSI standards.

It is also to be noted that the primary and secondary D-rings 28 and 30 could be replaced by other attachment means that also meet or exceed CSA or ANSI standards such as, for example, carabineers.

The rescue lanyard 10 is designed to be attached to the dorsal D-Ring of any CSA Z259.10 or ANSI Z359.1 harness as an adapter or connector. Advantageously, the rescue lanyard 10 is to stay attached to the harness 11 at all time and becomes part of any connecting means used when the harness 11 is used. More specifically, to attach the rescue lanyard 10 to the harness 11, the loop 16 of the primary strap 12 is first passed through the dorsal D-ring 42 of the safety harness 11. The main D-ring 28 of the rescue lanyard 10 is then slipped through the loop thereby attaching the rescue lanyard 10 to the harness 11. Alternatively, connecting hardware can simply be attached to the harness D-ring (not shown) or manufactured to the harness 11 (not shown).

FIG. 3 illustrates the rescue lanyard 10 having its primary D-ring 28 securely attached to a standard CSA, ANSI snap hook 40 and its primary strap 14 securely attached to the D-ring 42 of the harness 11 worn by the user 13 as described hereinabove. The snap hook 40 is secured to the structure 15 and can be seen as being an integral part thereof.

The user 13 is shown in a simulated rescue requiring position in FIGS. 3 to 9. More specifically, the user 13 cannot reach any point of contact to help him reach the ground safely.

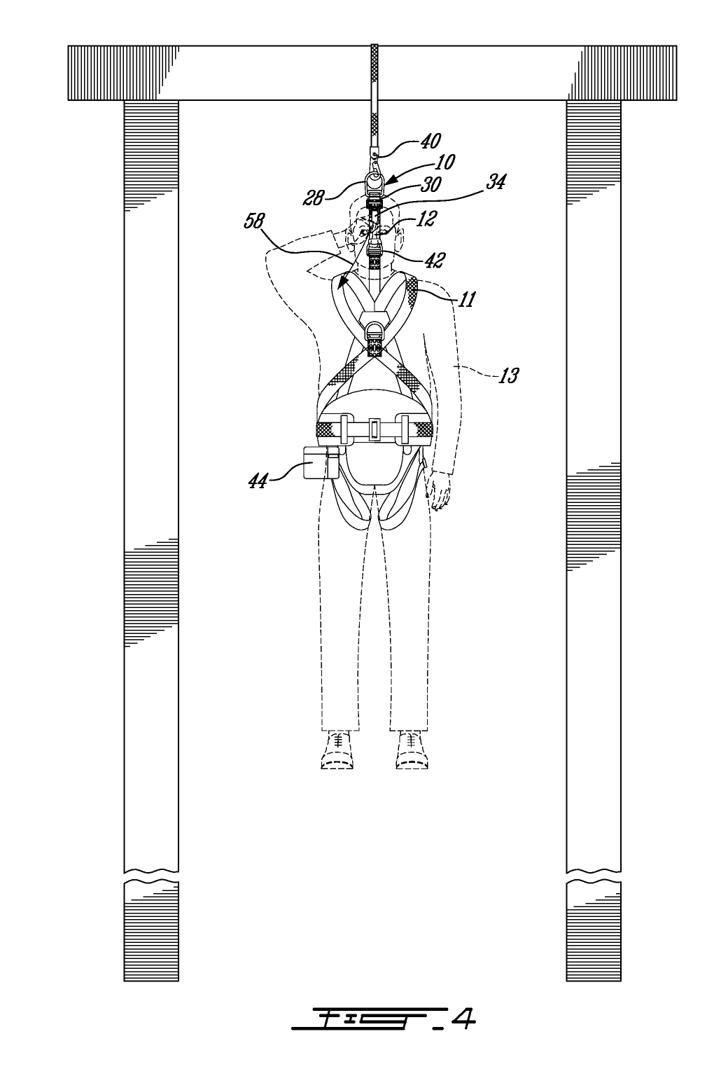

FIGS. 4 to 9 will illustrate an example of the various steps to be performed by the user 13 to reach safety.

It is to be noted that the rescue lanyard 10 is designed to be used with an emergency descent control package 44, supplied for example at time of purchase of the rescue lanyard 10. Of course, emergency descent control packages such as 44 can be acquired separately. The emergency descent control package 44 is advantageously worn on the harness 11 at all time or at the belt of the user 13 for example.

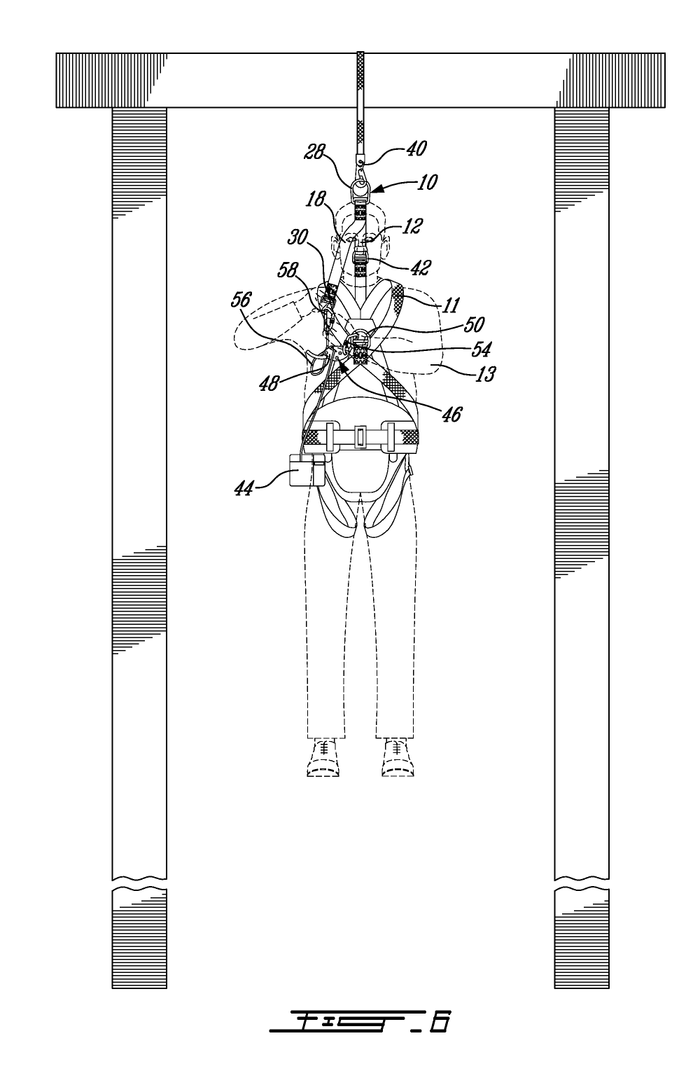

Turning briefly to FIG. 6, the emergency descent control package 44 is in the form of a small package including a strap cutter (not shown) and an emergency descent control device 46 including a rope-friction controller 48 to be mounted to a frontal D-ring 50 of the harness 11 via a carabineer 54, a rope 56 passing through the rope-friction controller 48 and provided with a second carabineer 58.

According to the first illustrative embodiment, the strap cutter is a slit-type cutter including a finger-receiving hole and a notch having a blade therein for receiving and cutting the main strap 12. According to a more specific illustrative embodiment of the present invention, the secondary strap 18 is thicker than the main strap and the notch of the cutter is so sized as to only allow inserting the main strap therein so as to prevent inadvertent cutting of the secondary strap 18.

Also, according to still a further illustrative embodiment of the present invention, the cutter is attached to the package 44, for example via a cord secured to the finger-receiving hole, so as to prevent inadvertent dropping of the cutter to the ground.

The device manufactured by Sécurité Landry under model number DSSR07 has been found adequate to be used as the emergency descent control device 46. Such an emergency descent control device 46 includes a 4 mm Vectran™ rope 56. Any other rope with sufficient tensile strength, for example sufficient to withstand the weight of a man, can also be used. Examples of such ropes include, without limitations, Technora™ and Dynema™ ropes.

It will easily be understood by one skilled in the art that the order of some of the steps described hereinbelow is not critical for the rescue operation to succeed.

The first step is shown in FIG. 4 and generally consists in locating the release loop 34 secured to the secondary D-ring 30, i.e. slightly below the main D-ring 28. When the release loop 34 is located, the user 13 forcefully pulls down on the loop 34 (see arrow 58) to release the secondary strap 18 from the pouch 36.

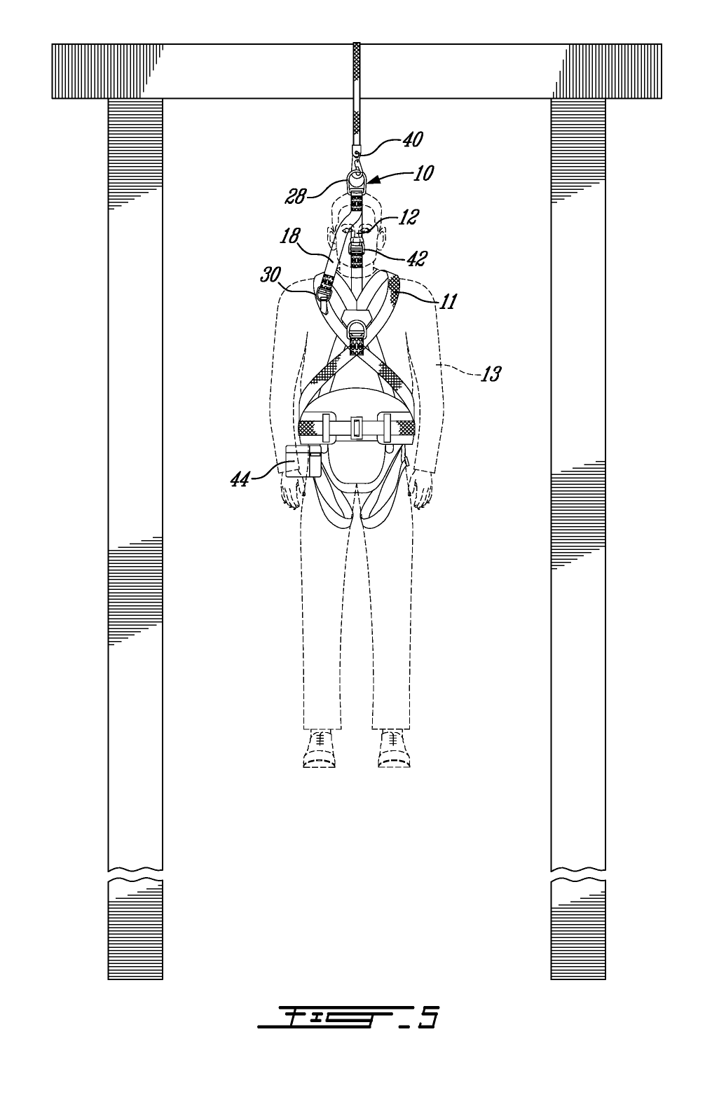

The result of this step is illustrated in FIG. 5 where the secondary strap 18 hangs in front of the user 13.

The user 13 then reaches in the emergency descent control package 44 to release the emergency descent control device 46. As can be seen from FIG. 6, a first carabineer 54 is secured to the front D-ring 50 of the harness 11 and a second carabineer 58, the one attached to the rope 56, is secured to the D-ring 30 of the secondary strap 18. The user 13 then verifies the tightness of the rope 56 between the harness 11 attachment and the D-ring 30 of the secondary strap 18, by pulling it upward from the descent device 46.

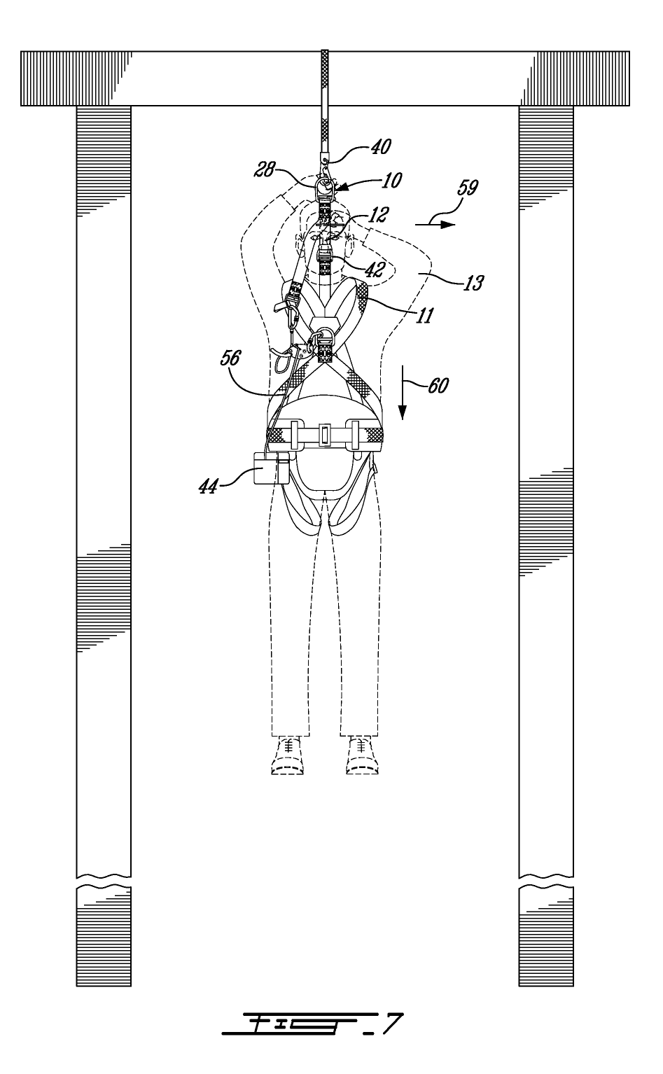

The user 13 then reaches in the package 44 to retrieve the strap cutter (not shown) and uses it to cut the primary strap 12 (see arrow 59) as illustrated in FIG. 7. The primary strap 12 can be provided with markings (not shown) to indicate one or more cutting positions to the user 13. It is to be noted that the user 13 may slightly balance backward when the primary strap 12 is cut since his weight pass from back attachment point to front attachment point.

As an advantageous feature of the present invention, the falling of the user 13 is prevented even though the secondary strap 18 or the rope 56 is inadvertently cut instead of the primary strap 12. The user would however be prevented to descent to the ground as will now be described.

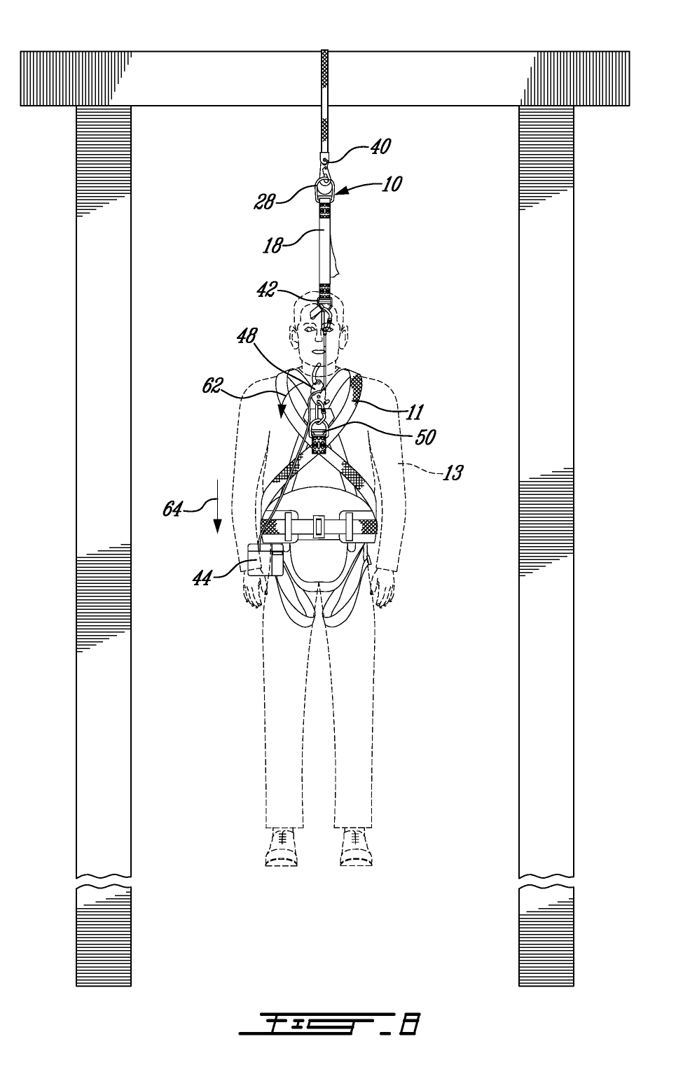

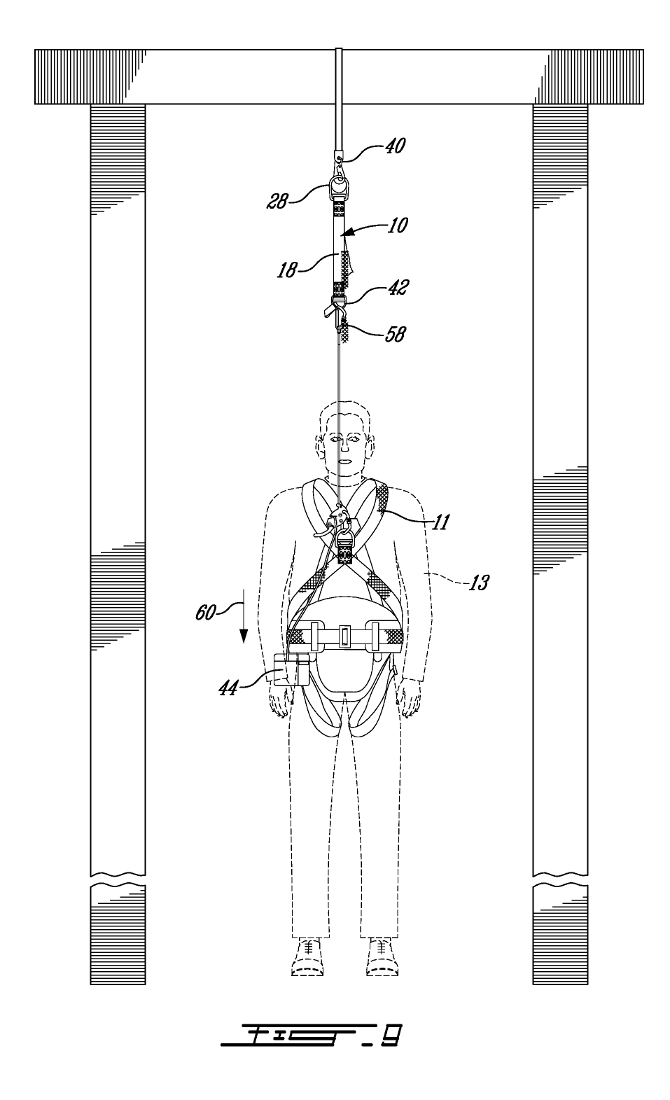

FIG. 8 shows the user 13 suspended by the front D-ring 50 of the harness 11. The user 13 may then use the descent device 46 (see arrow 62) to descent to the ground (see arrow 64) in a controlled manner until the ground is reached as shown in FIG. 9.

It is to be noted that many modifications could be made to the lanyard 10 or to the emergency descent control package 44 described hereinabove for example:
the lanyard 10 can be attached to any structure allowing to securely receive the first attachment portion 14 thereof directly or via a rope, a cable, a chain, a strap or other, which can be provided with a snap hook or with any other attachment;
even though the attachment portions 14, 16 and 20 are illustrated as being in the form or including a loop or a D-ring, each of the attachment portions 14, 16 and 20 can take other form or include other attachment or securing means allowing the attachment of the main and secondary straps 12 and 18 to respectively the structure 15 and the harness 11 and the harness 11 and the control descent device 46;
the lanyard 10 can be used with other forms of wearable safety equipment than the illustrated harness 11;
the secondary strap 18 can be attached to the main strap 12 using any attaching means including without limitations fasteners, glue, stitches, a knot, etc. The main and secondary straps 12 and 18 can also be integral; and any one of the first and secondary straps 12 and 18 can be replaced by a general link being in the form, for example, of a rope, a cable, a chain or else;
the emergency descent control package 44 can be provided with other descending device than the illustrated control descent device 46;
the rescue lanyard 10 can be made independent or integral to the harness 11 or to any other wearable safety equipment. Indeed, a harness according to a further illustrative embodiment of the present invention (not shown) can be manufactured so as to integrally include a lanyard having the characteristics of the lanyard 10.

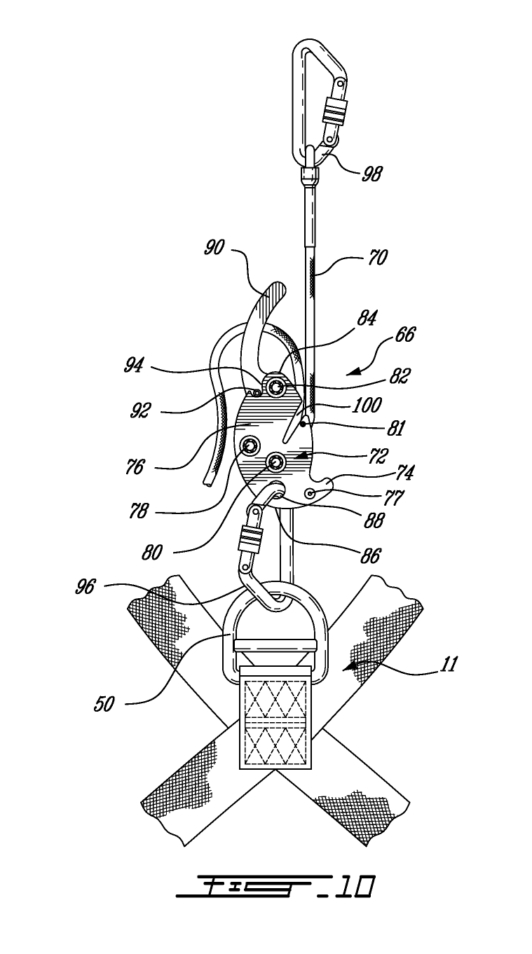

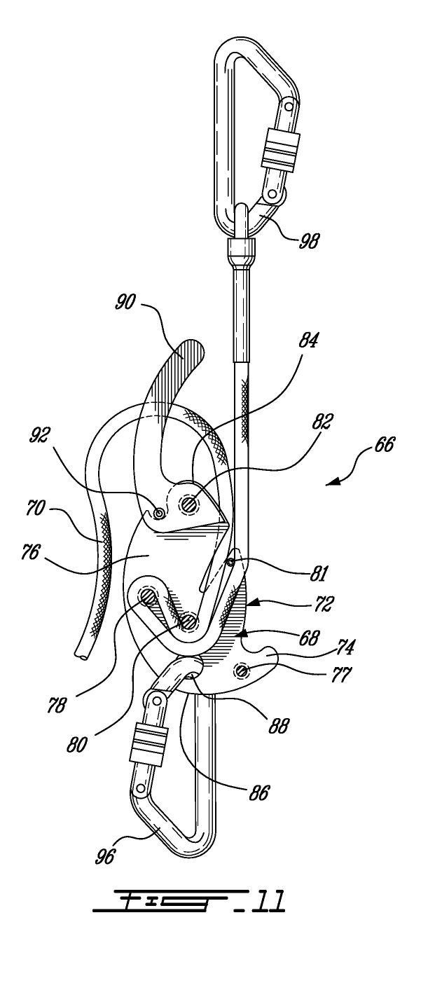

An emergency descent control device 66 according to a second illustrative embodiment of the present invention will now be described with reference to FIGS. 10 and 11.

As described with reference with the emergency descent control device 46 according to the second illustrative embodiment, the device 66 is to be mounted between a safety harness 11 or to any other safety wearable equipment and any anchorage point (not shown) capable of withstanding the required forces and from which a user equipped with the device 66 whishes to descent. As will become more apparent upon reading the following description, the emergency descent control device 66 includes a panic operational mode which prevents a user operating the device 66, which may be in a psychological distress for example, from speeding to the ground by misusing the device 66.

The device 66 comprises a rope friction controller 72, a rope 70 passing through the friction controller 72, and a safety element 74 for selectively applying friction on the rope 70 in a panic mode of operation of the device 66.

The friction controller 72 includes two identical elongated plates 76 distanced and assembled by bushing/pivot elements 77-82 further acting as pivot points and/or friction members for the rope 70 as will be described furtherin in more detail. The gap between the two plates 76 defines a rope-receiving portion for receiving a portion of the rope 70 therein and for selectively applying friction thereon. The distance between the first and second plates 76 is adapted for the calibre of the rope 70. More specifically, the rope 70 is snugly received in the rope-receiving portion of the friction controller 72.

According to the second illustrative embodiment, the friction controller 72 is generally oblong and defines first and second longitudinal ends 84 and 86.

The two plates 76 are made of a heavy-duty material such as, without limitations, a metal, a high-density polymer or a composite material.

The rope friction controller 72 further includes an attachment portion, in the form of registered holes 88 in the plates 76 adjacent the second longitudinal end 86, for securing the emergency descent control device 66 to the harness 11 of a user (not shown) and defining a pivot axis for the device 66.

The rope friction controller 72 further includes a handle 90, distanced from the attachment portion 88, for pivoting the rope friction controller 72 about the pivot axis 88 from a neutral position wherein friction is so applied on the rope 70 as to prevent movement thereof in the rope-receiving portion, to a descent position wherein minimal friction is applied on the rope 70 so as to allow movement thereof in the rope-receiving portion.

The handle 90 is pivotably mounted to the two plates 76 therebetween via a pivot pin 82, which is secured to both plates therebetween adjacent the first longitudinal end 84, so as to be retractable. The proximate end of the handle 90 includes a mechanical stop, in the form of a protruding pin 92, which contacts a recess 94 in both plates 76 adjacent where the pivot pin 82 is mounted. Of course, there is sufficient friction between the handle 90 and the two plates 76 to prevent the undesired retraction of the handle 90 during operation of the device 66.

The retractability of the handle 90 allows providing for a more compact device 68 when it is not in use. For that purpose, the handle 90 is also arcuate so as to complement the shape of the rope friction controller 72 when it is retracted.

According to a further illustrative embodiment (not shown), the handle 90 is fixedly mounted to the rope friction controller 72.

The friction members 7-81 of the rope-friction controller 72 will now be described in further detail.

A first friction member, defined by the pivot pin 81, is provided on a first lateral side of the plates 76 therebetween and is longitudinally positioned between the handle 90 and the attachment portion 88. The pivot pin 81, together with the bushing element 82, defines a rope inlet for the rope-receiving portion therebetween.

A second friction member, defined by the bushing element 80, defines a first pivot for the rope 70 in the rope-friction controller 72, and a third friction member, defined by the bushing element 78, defines a second pivot for the rope 70. The third friction member 78 is biased both laterally and longitudinally from the second friction member 80.

The peripheral portion of the rope-receiving portion, which is located between the pivot pin 81 and the attachment portion, defines a rope outlet for the rope-receiving portion.

With reference to FIG. 11, the rope 70 passes through the friction controller 72 as follows: after entering the friction controller 72 from the rope inlet, at a first side thereof between the elongated plates 76 and between the handle 90 and the rod 81, the rope 70 passes one half turn around the pin 80 thereunder and then turns around the pin 78, then comes back around pin 80. The rope 70 then exits the friction controller 72 from its entering side but on the other side of the pin 81. Before exiting the friction controller 72, the rope 70 has pass under the pin 80 over the first turn.

As will become more apparent upon reading the description of the operation of the device 66 hereinbelow, changing the orientation of the friction controller, by its pivoting about the attachment portion 88, allows changing the amount of friction which is applied onto the rope 70 in the rope-receiving portion of the friction controller 72 by the friction elements 78-81, thereby allowing to control a descent using the device 66.

An attachment, such as the carabineer 96, can be mounted in the hole 88 for securing the device 66 to the front D-ring 50 of the harness 11. The attachment can take other form allowing securing the device 66 via the hole 88 to the harness 11, including a rope, a cable, a chain, webbing or other.

According to a further illustrative embodiment (not shown), the hole 88 is omitted and the attachment is pivotably secured to the friction controller 72.

As will become more apparent upon reading the following description, the hole 88, and more generally the portion of the friction controller 72 that receives the attachment 96, defines a pivot axis for the device 66 during the operation thereof.

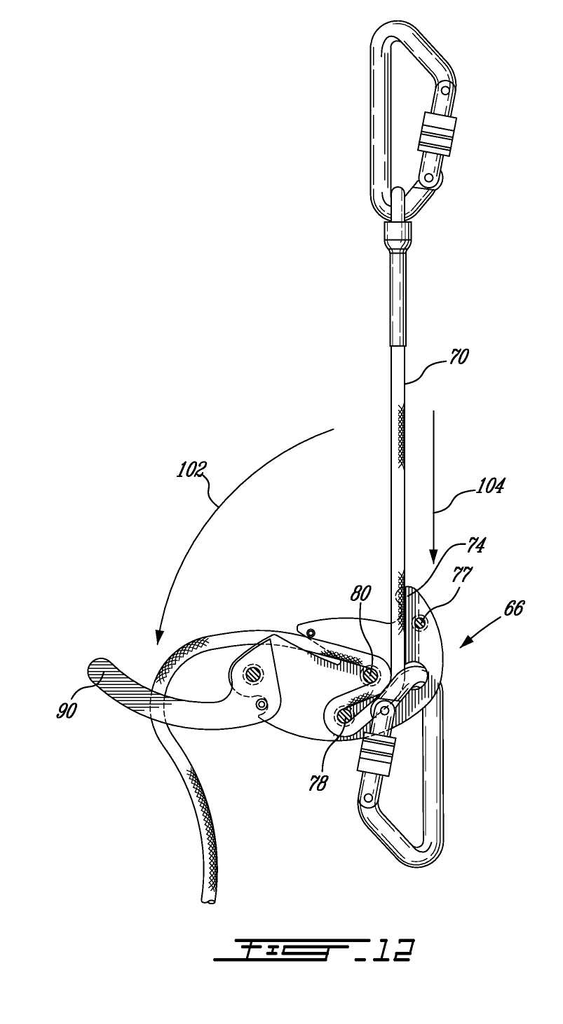

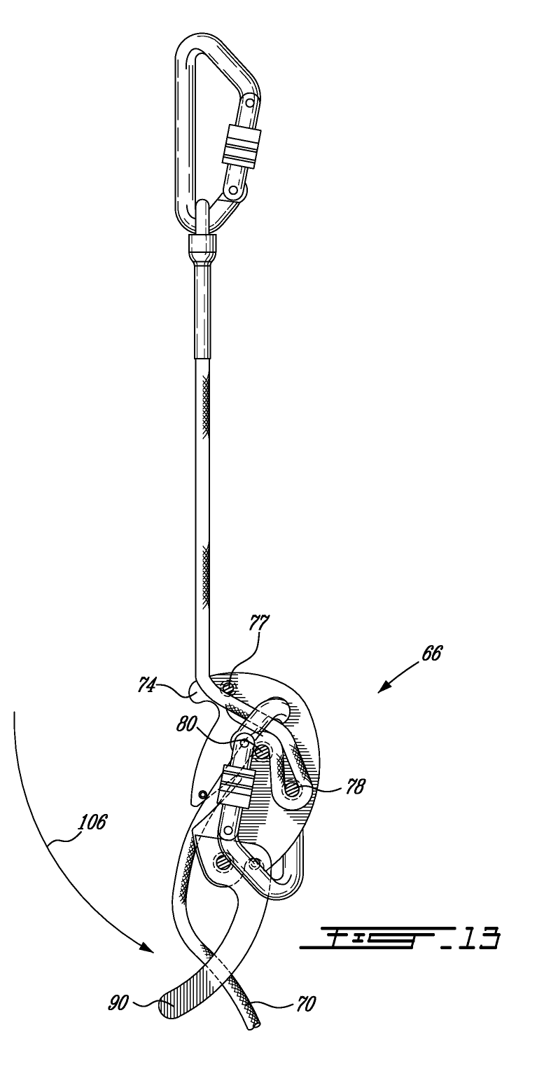

As will also become more apparent upon reading the following description, the handle 76 allows moving the rope friction controller 72 between a default friction position (illustrated in FIGS. 10 and 11), a non-friction position (illustrated in FIG. 12) and a forced friction position (illustrated in FIG. 13) by allowing to pivot the friction controller 72 about the pivot axis defined by the hole 88. Each of these positions will be described hereinbelow in more detail.

The safety element 74 is in the form of a lip of the friction controller 72 in the rope outlet and wherein the rope-receiving portion is contracted so as to define a tapered groove. The safety element 74 allows applying friction on the rope 70 so as to prevent movement thereof in the rope-receiving portion when the rope friction controller 72 is pivoted beyond the descent or non-friction position from the neutral or default friction position as will be described hereinbelow in more detail.

A first end of the rope 70 can be provided with an attachment, such as a carabineer 98, for securing the device 66 to a structure (not shown). The attachment can take any other form including for example simply the end for the rope 70.

The unused portion of the rope 70 can be stored in a package, such as the package 44 shown in FIG. 3, in an ordinate fashion. The package 44, which may be designed to include the device 66 before use, can be worn by the user 13 during descent to feed the rope 70. The package 44 can be adapted to further receive different type of harness or other body holding device (not shown).

The friction controller 72 further includes a tapered groove 100 adjacent the pin 81 on the side of the element 74 and which is so generally oriented as to extend towards the pin 80. The groove 100 is provided as an additional safety feature. Indeed, if the user drops the unused portion of the rope 70, the groove 100 is configured so that the rope 70 tends to jam therein, thereby causing the descent to stop.

The rope friction controller 72 and more specifically the configuration of the small pins 78-81 will now be described in more detail with reference to the operation of the device 66.

FIGS. 10 and 11 show the emergency control descent device 66 in its neutral or default friction position.

This position is said to be a default friction position since i) tension applied on the rope 70 by the weight of the user 13 causes the device 66 to naturally get into this position, and ii) the weight of the user causes friction to be applied on the rope 70 by the pivot/friction member 80, resulting on the rope 70 to be prevented from moving in the friction controller 72 and therefore on the user 13 hanging to the device 66 from falling.

FIG. 12 illustrates the device 66 in a non-friction position after the user has moved the handle 90 so that it is positioned generally horizontal relatively to the portion 44 of the rope 70, which is vertically tensed by the weight of the user (see arrow 102).

By moving the device 66 from the default friction position (FIG. 11) to the non-friction position (FIG. 12), the rope friction controller 72 gradually reaches a point where not enough friction is applied to the rope 70 by the pin 80 under the weight of the user to prevent its movement in the friction controller 72. It is to be noted that there is sufficient space provided between the pins 78 and 80 to allow movement of the rope 70 in the rope-receiving portion of the friction controller 72.

The rope 70 then moves freely in the friction controller 72 and the user descends (see arrow 104). A control descent is obtained by giving a right angle to the handle 90. Of course, a sufficiently long rope 70 is provided for the application.

If the user panics or inadvertedly moves the handle 90 beyond the non-friction position (see arrow 106), the device 10 then moves to the forced friction position (illustrated in FIG. 13), which corresponds to a panic mode.

In this position, the rope 70 is prevented from moving by the tapered groove of the friction controller defining the safety element 74.

When the user moves the friction controller 72 out of the forced friction position by pivoting back the friction controller 72 towards the horizontal position, the rope 70 is moved out of the tapered groove 74 and the descent of the user 13 continues.

Even though the rope friction controller 72 is illustrated in FIGS. 10-13 as being oval in shape, it can have any other configuration that allows providing the illustrated configuration of the pivot/friction members 78-81 and of the safety element 74. For example, the friction controller can be in the form of a one piece moulded body (not shown) defining two portions distanced by an inter-space and allowing receiving the rope 70; the inter-space being provided with pivot/friction members allowing the three modes of operation described hereinabove.

It is to be noted that the configuration and/or positioning of the pivot/friction members 78-81 and of the safety element 74 may also differ without departing from the spirit and nature of the present invention.

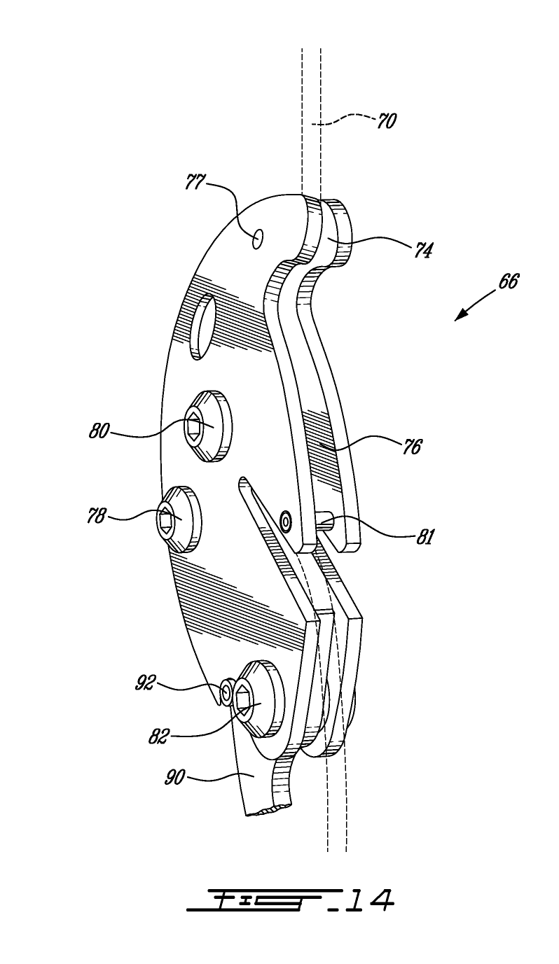

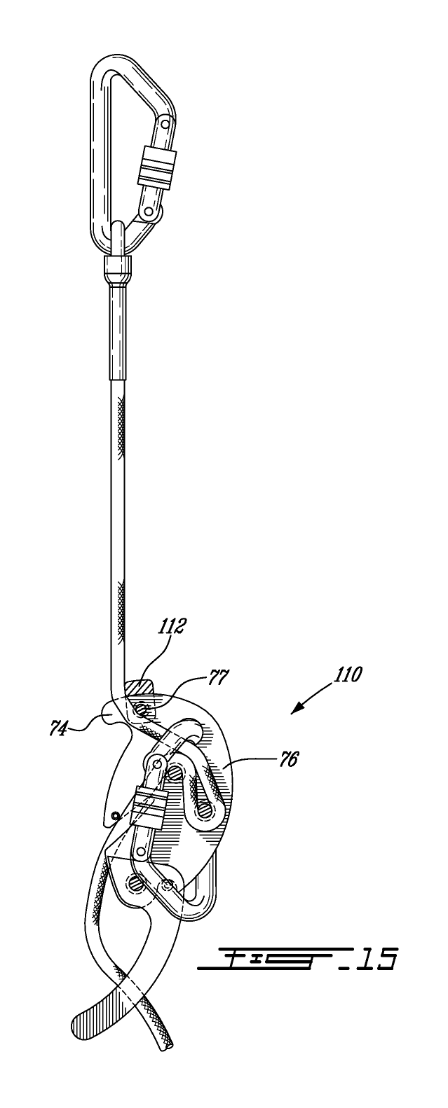

An emergency descent control device 110 according to a third illustrative embodiment of the invention will now be described with reference to FIG. 14. Since the device 110 is very similar to the device 66, only the differences between the two devices will be described herein in more detail.

The device 110 further includes a U-shaped bracket 112 secured to pin 77 so as to extend from the plates 76 from the peripheral edge thereof. The bracket 112 defines a further friction member increasing the overall friction on the rope when the device 110 is positioned in the forced friction position.

It is to be noted that many modifications could be made to the devices 66 and 110 described hereinabove for example:
the number, configuration and position of the friction members 78-81 in the friction controller 72 may differ than those illustrated; and
the safety element 74 can be integral to the friction controller 72 or can be secured thereto;
as mentioned hereinabove, the configuration and size of the friction controller 72, including those of the handle 90 may differ to those illustrated, depending for example on the application and/or on the caliber of the rope used.

Of course, the emergency descent control device 66 or 110 can be used independently from the lanyard 10.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of illustrative embodiments thereof, it can be modified, without departing from the spirit, scope and nature of the subject invention as defined in the appended claims.

What is claimed is:

1. A rescue lanyard to be used with a wearable safety equipment worn by a person, the lanyard comprising:
a main link having a first attachment portion for attaching the main link to a structure and a second attachment portion for attaching the main link to the wearable safety equipment;
a secondary link secured to the main link adjacent the first attachment portion and having a third attachment portion to be attached to the wearable safety equipment via a descending device;
whereby, in a safety mode of operation, the first attachment portion of the main link is attached to the wearable safety equipment and the second attachment portion is attached to the structure so as to retain the person wearing the wearable safety equipment during a fall; in a rescue mode of operation of the rescue lanyard following a fall, while the person hang from the main link, the third attachment portion is first attached to the wearable safety equipment via a descending device and the main link then being cut so as to allow the person to descent from the structure using the descending device.

2. An emergency descent control device as recited in claim 1, wherein the main and secondary links are straps.

3. An emergency descent control device as recited in claim 2, wherein the main and secondary straps are sewed together.

4. An emergency descent control device as recited in claim 2, wherein at least one of the first, second and third attachment portions includes a loop.

5. An emergency descent control device as recited in claim 2, wherein at least one of the first, second and third attachment portions includes an attachment.

6. An emergency descent control device as recited in claim 2, wherein the secondary strap is held in a breakable pouch.

7. An emergency descent control device as recited in claim 6, wherein the secondary strap includes a loop for pulling on the secondary strap for easing a release thereof from the pouch.

8. An emergency descent control device as recited in claim 2, wherein the wearable safety equipment is a safety harness.

9. An emergency descent control device as recited in claim 2, wherein the secondary strap is longer than the main strap.

10. A kit for an emergency descent from a high structure to be used with a wearable safety equipment, the kit comprising:
a rescue lanyard as recited in claim 1; and
an emergency descent control package including an emergency descent control device including a rope-friction controller to be secured to both the wearable safety equipment and to the rescue lanyard therebetween, a rope operatively coupled with the rope-friction controller, and a link cutter for cutting the main link of the rescue lanyard in a rescue mode of operation thereof after the rope-friction controller is secured to both the wearable safety equipment and to the rescue lanyard; the rope together with the rope-friction controller allowing for a controlled descent from the high structure of a user wearing the wearable safety equipment after i) the rope-friction controller is secured to both the wearable safety equipment and to the rescue lanyard and ii) the main link of the rescue lanyard is cut.

11. A kit as recited in claim 10, wherein the secondary link is thicker than the main link; the link cutter being configured to selectively receive the main link but not the secondary link.

12. An emergency descent control device to be secured to a wearable safety equipment, the device comprising:
a rope;
a rope friction controller having an attachment portion for securing the device to the wearable safety equipment and defining a pivot axis for the device, a rope-receiving portion having a rope inlet and a rope outlet for receiving a portion of the rope and for selectively applying friction thereon, and a handle portion distanced from the attachment portion for pivoting the rope friction controller about the pivot axis from a neutral position wherein friction is so applied on the rope as to prevent movement thereof in the rope-receiving portion to a descent position wherein minimal friction is applied on the rope so as to allow movement thereof in the rope-receiving portion; and
a safety element mounted to the rope-friction controller in the rope outlet for applying friction on the rope so as to prevent movement thereof in the rope-receiving portion when the rope friction controller is pivoted beyond the descent position from the neutral position.

13. An emergency descent control device as recited in claim 12, wherein the attachment portion includes a hole for receiving an attachment.

14. An emergency descent control device as recited in claim 12, wherein the handle portion includes a handle mounted to the rope-receiving portion.

15. An emergency descent control device as recited in claim 12, wherein the rope friction controller includes two distanced plates defining a gap therebetween; the gap defining the rope receiving portion.

16. An emergency descent control device as recited in claim 12, wherein the rope-receiving portion includes a contracted portion in the rope outlet which defines the safety element.

17. An emergency descent control device as recited in claim 12, wherein the safety element includes a U-shaped bracket.

18. An emergency descent control device as recited in claim 12, wherein the rope friction controller includes at least two friction elements within the rope-receiving portion between the attachment portion and the handle portion; the safety friction element being positioned longitudinally beyond the at least two friction elements relatively the first attachment portion; and the rope inlet and outlet both being positioned laterally on a same side than the safety friction element relatively to the at least two friction elements longitudinally between the handle portion and the first attachment portion.

19. An emergency descent control device as recited in claim 12, wherein a distal end of the rope is provided with an attachment.
